(19) United States
(12) Patent Application Publication
(10) Pub. No.: US 2026/0163839 A1
(43) Pub. Date: Jun. 11, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 19/126,948

(22) PCT Filed: Nov. 3, 2022
(86) PCT No.: PCT/CN2022/129685

§ 371 Date: May 2, 2025

(51) Int. Cl. H04L 47/2408; H04L 47/32

(52) U.S. Cl. CPC H04L 47/2408; H04L 47/32

(57) ABSTRACT

A method and system for efficient information processing in a communication network comprising a first network node and a second network node. The method includes transmitting auxiliary information from the first network node to the second network node to indicate discarding of one or more data packets. The auxiliary information may include packet discarding strategy information, association information indicating relationships between data packets and data packet sets, or state information specifying whether a data packet has failed to be sent or retransmitted. The auxiliary information can be generated in response to changes in bearer configuration, such as bearer switching, addition, or modification. The second network node uses the received auxiliary information to determine whether to discard specific data packets or packet sets. The disclosed techniques apply to scenarios involving master and secondary node relationships and support improved handling of packet discards in dynamic transmission environments.

### CROSS-REFERENCE TO RELATED APPLICATION

The application is a U.S. National Stage of International Application No. PCT/CN 2022/129685 filed on Nov. 3, 2022, the entire content of which is incorporated herein by reference.

### TECHNICAL FIELD

The present disclosure relates to but is not limited to, the technical field of wireless communications, and in particular, to an information processing method and apparatus, a communication device, and a storage medium.

### BACKGROUND

At present, the working mechanism of the Packet Data Convergence Protocol (PDCP) layer may be that when there is a change in the base station for the bearer, the PDCP layer state information needs to be transferred from the first base station (such as the source base station) to the second base station (such as the target base station). If one data packet in one data packet set (Packet set) is not sent successfully, it means that the other data packets in the data packet set do not need to be sent anymore.

### SUMMARY

Embodiments of the present disclosure provide an information processing method and apparatus, a communication device, and a storage medium.

According to a first aspect of the embodiments of the present disclosure, there is provided an information processing method, which is performed by a first network node and includes:
sending auxiliary information to a second network node, where the auxiliary information is used to indicate discarding of a data packet.

According to a second aspect of the embodiments of the present disclosure, there is provided an information processing method, which is performed by a second network node and includes:
receiving auxiliary information sent by a first network node, where the auxiliary information is used to indicate discarding of a data packet.

According to a third aspect of the embodiments of the present disclosure, there is provided an information processing apparatus, including:
a sending module, configured to send auxiliary information to a second network node, where the auxiliary information is used to indicate discarding of a data packet set.

According to a fourth aspect of the embodiments of the present disclosure, there is provided an information processing apparatus, including:
a receiving module, configured to receive auxiliary information sent by a first network node, where the auxiliary information is used to indicate discarding of a data packet.

According to a fifth aspect of the present disclosure, a communication device is provided, and the communication device includes:
a processor; and
a memory for storing instructions executable by the processor;
where the processor is configured to implement the information processing method of any embodiment of the present disclosure when running the executable instructions.

According to a sixth aspect of the present disclosure, a computer storage medium is provided, where the computer storage medium stores a computer executable program, and the executable program, when being executed by a processor, implements the information processing method of any embodiment of the present disclosure.

It should be understood that the above general description and the following detailed description are only exemplary and explanatory, and cannot limit the embodiments of the present disclosure.

### BRIEF DESCRIPTION OF THE DRAWINGS

FIG. 1 is a schematic structural diagram of a wireless communication system shown according to an exemplary embodiment.

FIG. 2 is a schematic diagram of an information processing method shown according to an exemplary embodiment.

FIG. 3 is a schematic diagram of an information processing method shown according to an exemplary embodiment.

FIG. 4 is a schematic diagram of an information processing method shown according to an exemplary embodiment.

FIG. 5 is a schematic diagram of an information processing method shown according to an exemplary embodiment.

FIG. 6 is a schematic diagram of an information processing method shown according to an exemplary embodiment.

FIG. 7 is a schematic diagram of an information processing method shown according to an exemplary embodiment.

FIG. 8 is a schematic diagram of an information processing method shown according to an exemplary embodiment.

FIG. 9 is a schematic diagram of a processing method for packet discarding shown according to an exemplary embodiment.

FIG. 10 is a schematic diagram of an information processing apparatus shown according to an exemplary embodiment.

FIG. 11 is a schematic diagram of an information processing apparatus shown according to an exemplary embodiment.

FIG. 12 is a block diagram of a UE according to an exemplary embodiment.

FIG. 13 is a block diagram of a base station according to an exemplary embodiment.

### DETAILED DESCRIPTION

Exemplary embodiments will be described in detail here, and examples thereof are shown in the accompanying drawings. When the following descriptions refer to the figures, the same numbers in different figures indicate the same or similar elements, unless otherwise indicated. The implementations described in the following examples do not represent all implementations consistent with the embodiments of the present invention. Instead, they are merely examples of apparatuses and methods consistent with some aspects of the embodiment of the present invention as detailed in the appended claims.

The terms used in the embodiments of the present disclosure are only for the purpose of describing specific embodiments, and are not intended to limit the embodiments of the present disclosure. The terms “a/an”, “said”, and “the” in the singular form used in the embodiments of the present disclosure and the appended claims are also intended to include the plural form, unless otherwise clearly indicated in the context. It should be further understood that the term “and/or” used in the present disclosure refers to and includes any or all possible combinations of one or more of the items listed in the associated disclosure.

It should be understood that although the terms “first”, “second”, “third”, etc. may be used in the embodiments of the present disclosure to describe various information, the information should not be limited to these terms. These terms are merely used to distinguish the same type of information from one another. For example, without departing from the scope of the embodiments of the present disclosure, the first information may also be referred to as second information, and similarly, the second information may also be referred to as first information. Depending on the context, the word “if” as used here may be interpreted as “when” or “upon” or “in response to determining”.

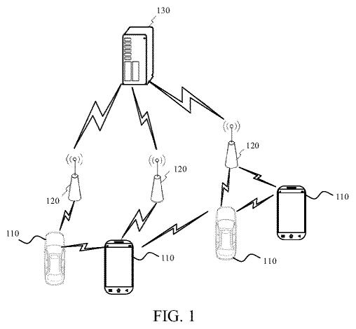

Referring to FIG. 1, which shows a schematic structural diagram of a wireless communication system provided by an embodiment of the present disclosure. As shown in FIG. 1, the wireless communication system is a communication system based on a cellular mobile communication technology, and the wireless communication system may include: a plurality of user equipments 110 and a plurality of base stations 120.

The user equipment 110 may refer to a device for providing voice and/or data connectivity to a user. The user equipment 110 may be in communication with one or more core networks via a radio access network (RAN), and the user equipment 110 may be an Internet of Things user equipment, such as a sensor device, a mobile phone (or “cellular” phone), and a computer with the Internet of Things user equipment, for example, may be a fixed, portable, pocket-sized, handheld, computer-built-in or vehicle-mounted apparatus. For example, a station (STA), a subscriber unit, a subscriber station, a mobile station, a mobile, a remote station, an access point, a remote user equipment, an access terminal, a user terminal, a user agent, a user device, or a user equipment. Alternatively, the user equipment 110 may also be an unmanned aerial vehicle device. Alternatively, the user equipment 110 may also be a vehicle-mounted device, for example, may be a trip computer with a wireless communication function, or may be a wireless user equipment connected to the trip computer externally. Alternatively, the user equipment 110 may also be a roadside device, for example, may be a street lamp having the radio communication function, a signal light, or other roadside devices.

The base station 120 may be a network side device in the wireless communication system. The wireless communication system may be the 4th generation mobile communication technology (4G) system, also referred to as a long term evolution (LTE) system; or, the wireless communication system may also be a 5G system, also referred to as a new air interface system or a 5G NR system. Alternatively, the wireless communication system may also be a next generation system of the 5G system. An access network in the 5G system may be referred to as a new generation-radio access network (NG-RAN).

The base station 120 may be an evolved base station (eNB) used in the 4G system. Alternatively, the base station 120 may also be a base station (gNB) using a centralized distribution architecture in the 5G system. When the base station 120 uses the centralized distributed architecture, a central unit (CU) and at least two distributed units (DU) are included usually. The central unit is provided with a protocol stack of a packet data convergence protocol (PDCP) layer, a radio link control (RLC) protocol layer, and a media access control (MAC) layer; and the distributed unit is provided with a protocol stack of a physical (PHY) layer, and the embodiments of the present disclosure do not limit the specific implementations of the base station 120.

A wireless connection may be established between the base station 120 and the user equipment 110 through the wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard after 5G.

In some embodiments, end to end (E2E) connection may further be established between the user equipments 110. For example, scenarios such as vehicle to vehicle (V2V) communication, vehicle to infrastructure (V2I) communication, and vehicle to pedestrian (V2P) communication in vehicle to everything (V2X) communication.

Here, the above user equipment may be considered as the terminal device of the following embodiments.

In some embodiments, the wireless communication system may further include a network management device 130.

A plurality of base stations 120 are connected with the network management device 130 respectively. The network management device 130 may be a core network device in the wireless communication system, for example, the network management device 130 may be a mobility management entity (MME) in an evolved packet core network (EPC). Alternatively, the network management device may also be other core network devices, such as a serving gateway (SGW), a public data network gateway (PGW), a policy and charging rules function (PCRF) unit, or a home subscriber server (HSS); or the core network device may also be a core network device in 5G; for example, it may be an access and mobility management function (AMF), a policy control function (PCF) or a session management function (SMF). The embodiments of the present disclosure do not limit the implementation form of the network management device 130.

In order to facilitate the understanding of those skilled in the art, the embodiments of the present disclosure list multiple implementations to clearly illustrate the technical solutions of the embodiments of the present disclosure. Of course, those skilled in the art can understand that the multiple embodiments provided by the embodiments of the present disclosure can be executed separately, or can be executed together with the methods of other embodiments in the embodiments of the present disclosure, or can be executed together with some methods in other related art separately or in combination. The embodiments of the present disclosure do not limit this.

It should be noted that when multiple execution entities are involved in the embodiments of the present disclosure, when one execution entity sends a transmission to another execution entity, it may refer to one execution entity sending the transmission directly to another execution entity, or it may refer to one execution entity sending the transmission to another execution entity through any other device, which is not limited in the embodiments of the present disclosure.

In order to better understand the technical solutions described in any embodiment of the present disclosure, some descriptions of the related art are given first.

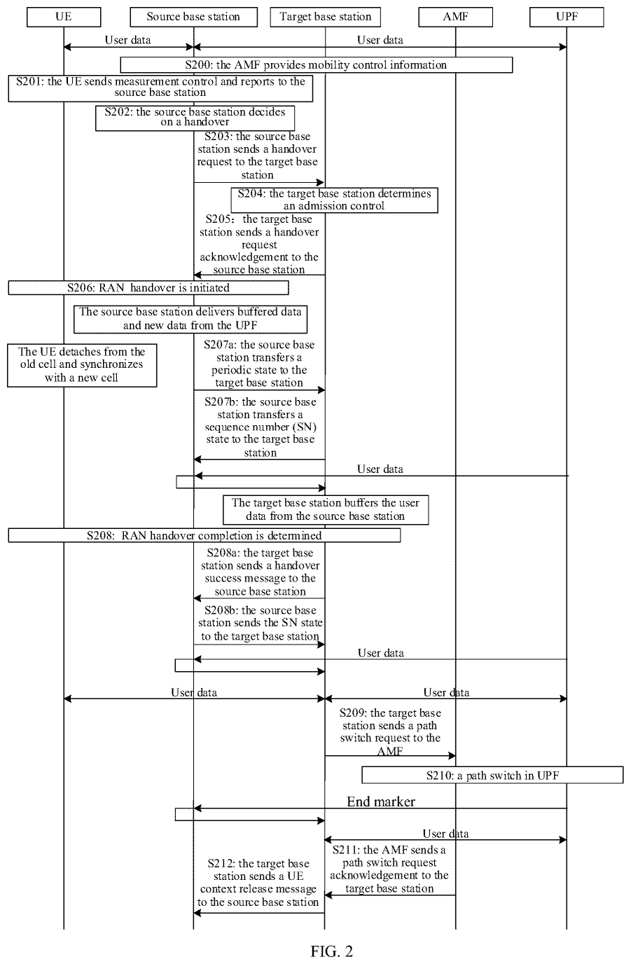

In some application scenarios, the working mechanism of the PDCP layer may be that when there is a change in the base station for the bearer, the PDCP layer state information needs to be transferred from the source base station to the target base station. As shown in FIG. 2, the embodiment of the present disclosure provides an information processing method, which is performed by communication devices. The communication devices include a UE, a source base station, a target base station, an AMF, and a user plane function (UPF). The information processing method includes the following steps.

In step S200, the AMF provides mobility control information;

In an optional embodiment, before the step S200, it includes: the transmission of user data between the UE and the source base station; and/or the transmission of user data between the source base station and the UPF.

In step S201, the UE sends measurement control and reports to the source base station.

In step S202, the source base station decides on a handover.

In step S203, the source base station sends a handover request to the target base station.

In step S204, the target base station determines an admission control.

In step S205, the target base station sends a handover request acknowledgement to the source base station.

In step S206, the RAN handover is initiated.

In an optional embodiment, the information processing method includes: the source base station distributing buffered data and new data from the UPF.

In an optional embodiment, the information processing method includes: detaching the UE from an old cell and synchronizing the UE with a new cell. Here, the old cell may be a cell corresponding to the source base station, and the new cell may be a cell corresponding to the target base station.

In step S207a, the source base station transfers a periodic state to the target base station.

In step S207b, the source base station transfers a sequence number (SN) state to the target base station.

In an optional embodiment, the information processing method includes: the UPF sending the user data to the source base station; and/or the source base station sending the user data to the target base station.

In an optional embodiment, the information processing method includes: the target base station buffering the user data from the source base station.

In step S208, it is determined that the RAN handover is completed.

In step S208a, the target base station sends a handover success message to the source base station.

In step S208b, the source base station sends the SN state to the target base station.

In an optional embodiment, the information processing method includes: the UPF sending the user data to the source base station; and/or the source base station sending the user data to the target base station.

In another optional embodiment, the information processing method includes:
transmitting the user data between the UE and the target base station; transmitting the user data between the target base station and the UPF.

In step S209, the target base station sends a path handover request to the AMF.

Step S210 refers to a path switch in UPF.

In an optional embodiment, the UPF sends an end marker to the source base station; and the source base station sends an end marker to the target base station.

In step S211, the AMF sends a path switch request acknowledgement to the target base station.

In step S212, the target base station sends a UE context release message to the source base station.

In an optional embodiment, the method includes: the target base station sending the UE context release message to the UE.

Here, the steps S201 to S205 may be a handover preparation phase; the steps S206 to S207 may be a handover execution phase; and the steps S208 to S212 may be a handover completion phase.

Here, based on the above steps S207a and S207b, in the downlink direction, the source base station transmits the PDCP layer sequence number to the target base station, so that the target base station can calculate and/or send the sequence number of the new data packet obtained from the core network at the base station. At this moment, the previously transmitted data packet also includes the data packet that has not received the UE confirmation. That is, for the target base station, the target base station needs to send two types of data packets (at the PDCP layer): one is the data packet previously transmitted from the source base station, and the other is the new data packet received by the core network.

In some application scenarios, in Extended Reality (XR) services, data may be distinguished according to its importance. For example, data may be divided into data of I-frames and P-frames, where the I-frames are relatively important frames and the P-frames are relatively unimportant frames. Here, the UE can use the I-frames for decoding; and the P-frames cannot be decoded separately.

In one embodiment, a protocol data unit (PDU) set is introduced; the PDU set may be composed of multiple PDUs. Sometimes, all data in one PDU set need to reach the higher layer to be correctly decoded. However, sometimes, correct decoding can be achieved even if not all the data in a PDU set reach the higher layer.

In the communication standard, it can be expressed as:
PDU Set: A PDU Set is composed of one or more PDUs carrying the payload of one unit of information generated at the application level (e.g. a frame or video slice for XRM Services, as used in TR 26.926[27 ]). In some implementations all PDUs in a PDU Set are needed by the application layer to use the corresponding unit of information. In other implementations, the application layer can still recover parts all or of the information unit, when some PDUs are missing.

In one embodiment, the UPF identifies the PDU set, places it in the GTP-U header, and transfers it to the RAN. The UPF identifies the PDU set for the downlink (DL) PDU at the GTP-U layer through the GTP-U header extension. The GTP-U identifier is independent of and shared by the different PDU set identifiers between the access stratum (AS) and the UPF. The UPF identifies the PDUs belonging to one PDU set and the following information for each PDU set:
the information processed within the PDU set (i.e., PDU set integrated processing).

The basic parameters include at least one of the following:
the PDU set sequence number (SN);
identifiers of the start PDU and end PDU in the PDU set;
the PDU sequence number in the PDU set;
the number of PDUs in the PDU set and the size of the PDU set (in bytes);
the importance or importance level of the Packet set; and
the sequence number of the important PDU in the PDU Set.

Here, the start PDU may be implicitly indicated by the PDU sequence number.

In the communication standard, it can be expressed as:
UPF marks PDU Sets in GTP-U layer for DL PDU via GTP-U header extension. GTP-U marking is independent from and common to different PDU Set markings between AS and UPF.

UPF identifies the PDUs belong to a PDU Set and the following information for each PDU Set:
Info for intra-PDU Set handling (i.e. KI #4, PDU Set integrated handling).

Baseline parameters:
PDU Set Sequence number (SN) (solution 7, 8, 9, 11, 12, 14, 19, 20, 21, 22, 23, 50, 53, 55, 56).
Start/End PDU of the PDU Set (solution 11, 12, 15, 18, 21, 22, 55, 56).
PDU SN within a PDU Set (solution 11, 20, 22, 55, 56).
Number of PDUs within a PDU Set (solution 9, 20, 50) and/or PDU Set size in bytes.

It is possible that “Start PDU” can be implicitly indicated via the PDU SN. This is left to stage 3 to decide.

It can be seen that some basic parameters of the PDU set identified by the UPF may include at least one of the following: the sequence number of the PDU set; the sequence numbers of the start PDU and the end PDU (i.e. the sequence number of the first PDU or the last PDU in the PDU set); the number of PDUs contained in the PDU set; and the sequence numbers of the PDUs in the PDU set.

In some application scenarios, for the PDCP at the transmitting end, associated packet discarding for each data packet set (Packet set) needs to be carried out for packet discarding. For example:
For the UE transmitting end, PDCP packet discarding should be performed on the basis of each PDU set.

For the UE transmitting end, PDCP discarding is managed according to the Service Data Unit (SDU) in each PDU set. The PDCP entity discards all PDCP SDUs associated with the PDU set.

In the communication standard, it can be expressed as:
1. For UE transmitter, the PDCP discard should be performed per PDU set basis.
2. For UE transmitter, The PDCP discard is managed per SDU for PDU set, the PDCP entity discards all PDCP SDUs associated with the PDU set.

However, in terms of the current interaction of state information between base stations, the second base station does not know the association relationship between the data packets in the data packet set, etc. As a result, it is unable to accurately obtain the data packets that need to be discarded and perform operations such as discarding the data packets.

Embodiments of the present disclosure provide an information processing method and apparatus, a communication device, and a storage medium.

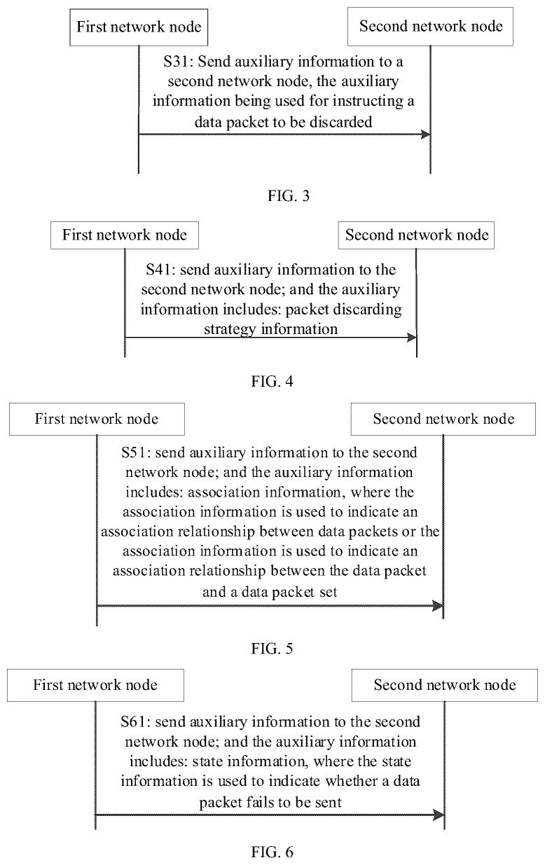

As shown in FIG. 3, an embodiment of the present disclosure provides an information processing method, which is performed by a first network node and includes the following steps.

In step S31, auxiliary information is sent to a second network node, where the auxiliary information is used to indicate discarding of a data packet.

An embodiment of the present disclosure provides an information processing method, which is performed by the first network node and includes: determining auxiliary information, where the auxiliary information is used to indicate the discarding of at least one data packet set.

Here, both the first network node and the second network node may be access network devices. The access network device may be, but is not limited to, a base station. The base station may be various types of base stations, for example, may be, but is not limited to, at least one of the following: a 3G base station, a 4G base station, a 5G base station, and other evolved base stations. Alternatively, the first network node and the second network node may also be flexibly arranged logical nodes or functions or entities implementing functions in the access network.

In one embodiment, the first network node is a master node (MN), and the second network node is a secondary node (SN).

In another embodiment, the first network node is a secondary node and the second network node is a master node.

In still another embodiment, the first network node is a source base station, and the second network node is a target base station.

In yet another embodiment, the first network node is a first base station, and the second network node is a second base station.

In one embodiment, the auxiliary information is used to indicate a node that receives the information to discard the data packet.

Here, the data packet may be: a part of the data packets or all of the data packets in at least one data packet set.

In one embodiment, the auxiliary information is used to indicate the discarding of a part of data packets in at least one data packet set and/or the discarding of all data packets in at least one data packet set. One data packet set includes one data packet or a plurality of data packets.

In one embodiment, the auxiliary information is used to indicate the discarding of one data packet set or a plurality of data packet sets; and one data packet set includes one data packet or a plurality of data packets. In the embodiment of the present disclosure, a plurality refers to two or more than two.

In one embodiment, the data packet set may be the PDU set in the above embodiments; the data packet may be a PDU; and the PDU set includes at least one PDU.

In one embodiment, the auxiliary information is used by the second network node to determine discarding of at least one data packet or a data packet set.

For example, the first network node sends auxiliary information to the second network node, where the auxiliary information is used to indicate discarding of at least one data packet and/or at least one data packet set; and the second network node determines to discard at least one data packet set based on the received auxiliary information.

In another embodiment, the auxiliary information is used for the second network node to determine discarding of at least one data packet.

For example, the first network node sends auxiliary information to the second network node, where the auxiliary information is used to indicate the discarding of at least one data packet set or at least one data packet; and the second network node determines the discarding of at least one data packet in the data packet set based on the received auxiliary information.

In the embodiments of the present disclosure, the first network node sends auxiliary information to the second network node so that the second network node can accurately know the discarding of the data packet. Furthermore, if the second network node discards the data packet, the occurrence of network congestion can be reduced.

An embodiment of the present disclosure provides an information processing method, which is performed by a first network node, and includes: sending auxiliary information to a second network node, where the auxiliary information is used to indicate the discarding of at least one data packet set; and one data packet set includes at least one data packet.

In this way, the embodiment of the present disclosure can enable the second network to discard batches of data packets.

In some embodiments, sending the auxiliary information to the second network node in step S31 includes: sending the auxiliary information to the second network node based on the bearer of the UE being switched from the first network node to the second network node.

The embodiment of the present disclosure provides an information processing method, which is performed by a first network node, and includes: based on a bearer of a UE or a PDCP termination point of the bearer being switched from the first network node to a second network node, sending auxiliary information to the second network node.

Exemplarily, when the UE is in dual connectivity (DC), and the bearer is switched from the first base station to the second base station, the first base station sends the auxiliary information to the second base station; and the auxiliary information is used by the second base station to determine discarding of a data packet set.

In the embodiments of the present disclosure, in a switching scenario in which the bearer of the UE is switched from the first network node to the second network node, the second network node can accurately know the data packet set that need to be discarded. In this way, the second network node can discard the data packet set in batches, thereby reducing the occurrence of network congestion to a certain extent.

In some embodiments, the second network node sending the auxiliary information in step S31 includes: sending the auxiliary information to the second network node based on the second network node being added to the bearer of the UE; and/or, sending the auxiliary information to a second network node based on the second network node being modified in the bearer of the UE. Here, the second network node is added to the bearer of the UE; and/or the second network node is modified in the bearer of the UE.

An embodiment of the present disclosure provides an information processing method, which is performed by a first network node, including: sending the auxiliary information to the second network node based on the second network node being added to the bearer of the UE; and/or sending the auxiliary information to a second network node based on the second network node being modified in the bearer of the UE.

In the embodiments of the present disclosure, when the second network node is added and/or modified, the second network node can accurately know the data packet set that needs to be discarded; thus, the network node can discard the data packet set in batches.

It should be noted that those skilled in the art can understand that the method provided in the embodiments of the present disclosure can be executed alone or together with some methods in the embodiments of the present disclosure or some methods in the related art.

In some embodiments, the auxiliary information includes: packet discarding strategy information, where the packet discarding strategy information is used to indicate under what circumstances the packet discarding is performed. Here, the packet discarding strategy information is used to indicate a packet discarding strategy for packet discarding.

As an embodiment, the packet discarding strategy includes a type 1 packet discarding strategy, that is, notifying the target entity under what circumstances the packet discarding occurs. For the type 1 packet discarding strategy, the receiving node (such as the second network node) will make a decision based on the packet discarding strategy and then perform packet discarding.

As an embodiment: the packet discarding strategy is as follows: when the first data packet in the data packet set fails to be sent, the second data packet associated with the first data packet is discarded.

As an embodiment: the packet discarding strategy is as follows: when the first data packet in the data packet set fails to be sent, all data packets in the data packet set associated with the first data packet are discarded.

As an embodiment: the packet discarding strategy is as follows: if the number of first data packets that fails to be sent in the data packet set is greater than or equal to a predetermined threshold, the second data packet associated with the first data packet is discarded, where the first data packet is any data packet in the data packet set or a data packet whose weight is greater than or equal to a predetermined weight.

As an embodiment, the packet discarding strategy includes a type 2 packet discarding strategy, that is, the sending entity directly informs the target entity which data packets should be discarded, such as the sequence number range of the data packets.

As an embodiment, the packet discarding strategy is: sending the SN number of the data packet set associated with the discarded data packet. In this case, the target node (such as the second network node) receives a data packet from the core network or from other nodes, and if the SN number of the data packet set associated with the data packet matches the SN number of the data packet set associated with the discarded data packet, the data packet can be directly discarded.

As an embodiment, the packet discarding strategy is: sending the SN value range of the data packet set associated with the discarded data packet. In this case, the target node receives a data packet from the core network or from other nodes. If the SN number of the data packet set associated with the data packet matches the SN value range of the data packet set associated with the discarded data packet, the data packet can be directly discarded.

As an embodiment, the interaction message between base stations carries the SN number or a list of SN numbers of the discarded data packet sets. When the target node receives a data packet from the core network, if it detects that the SN number of the data packet set associated with the data packet belongs to SNs of data packet sets of which data packets need to be discarded, the data packet can be directly discarded without transmission.

In other embodiments, other packet discarding strategies are not excluded.

For the node that receives the packet discarding strategy, the packet discarding strategy must be executed, that is, packet discarding is carried out; or it is not necessarily executed, that is, after making a judgment based on its own capabilities, if the node finds that its capabilities are sufficient, it does not necessarily perform packet discarding. In other words, after receiving the packet discarding strategy, the target node just takes the packet discarding strategy as a reference.

As an embodiment, the packet discarding strategy includes a type 2 packet discarding strategy, that is, the sending entity directly informs the target entity which data packets should be discarded. The target node then discards packets according to the auxiliary information and cannot refuse.

Regardless of the discarding strategy adopted, if the transmitting end (such as the first network node) has identified the characteristics of the data packets that need to be discarded, the transmitting end may avoid transmitting the data packets that need to be discarded when previously transmitting the data. Early discard can be achieved, which can save the overhead of forwarding data packets when previously transmitting the data.

As an example, the packet discarding strategy can be based on a single QoS flow or a single radio bearer configuration.

As shown in FIG. 4, an embodiment of the present disclosure provides an information processing method, which is performed by a first network node and includes the following steps.

In step S41, auxiliary information is sent to the second network node; and the auxiliary information includes: packet discarding strategy information.

In one embodiment, the packet discarding strategy information is used to indicate at least one of the following:
when the first data packet in the data packet set fails to be sent, discarding all data packets in the data packet set associated with the first data packet; and
if the number of failed first data packets in the data packet set is greater than or equal to a predetermined threshold, discarding the second data packet associated with the first data packet, where the first data packet is any data packet in the data packet set or a data packet whose weight is greater than or equal to a predetermined weight.

In another embodiment, the packet discarding strategy information is used to indicate any packet discarding strategy in the above embodiments.

In some embodiments of the present disclosure, the first network node and the second network node may be the first network node and the second network node respectively in the above embodiments; the data packet and the data packet set may be the data packet and the data packet set respectively in the above embodiments; and the auxiliary information may be the auxiliary information in the above embodiments.

In one embodiment, the second data packet includes at least one of the following:
a data packet in the same data packet set as the first data packet; and
a data packet in a different data packet set than the first data packet.

In one embodiment, the first data packet may also be the data packet of the I-frame in the above embodiment.

Here, the data packet set includes multiple data packets. One weight is determined for each data packet, and the weight is used to indicate the importance of the data packet. For example, the data packet set includes 10 data packets, and the weights of the 10 data packets may be 0.1, 0.2, 0.3, 0.4, 0.5, 0.6, 0.7, 0.8, 0.9 and 1 respectively; and the predetermined weight is 0.7. If the first network node determines that the data packet with a weight of 0.8 fails to be sent, and the packet discarding strategy information is used to indicate that when the transmission of a data packet with a weight greater than or equal to 0.7 fails, the data packets associated with the data packet with a weight greater than or equal to 0.7 are discarded. In this case, the first network node does not need to send data packets with the weights of 0.9 and 1, and the second network node determines that the data packet associated with the weight of 0.8 is discarded.

Here, the predetermined threshold value may be a value greater than or equal to a first number, or the predetermined threshold value may be a value greater than or equal to a first percentage. For example, if the data packet set includes 100 data packets, the predetermined threshold value may be 80; or, if the data packet set includes 100 data packets, the predetermined threshold value may be 75%.

For example, the data packet set includes a first data packet; and the first data packet is a data packet having a weight greater than or equal to a predetermined weight. The first network node sends auxiliary information to the second network node, the auxiliary information including packet discarding strategy information. The packet discarding strategy information is used to indicate that when the first data packet in the data packet set fails to be sent, the second data packet associated with the first data packet is discarded. If the second network node receives the auxiliary information and determines that the first data packet in the data packet set fails to be sent, the second network node discards the data packet set and/or discards the second data packet in the data packet set and/or discards other data packet sets where the second data packet is located. In this case, the second network node does not need to send the second data packet, etc. Here, the data packet having a weight greater than or equal to the predetermined weight may be an important data packet in the data packet set. For example, if the data packet set is a PDU set, the data packet having a weight greater than or equal to the predetermined weight may be a data packet carried by an I-frame.

In the above embodiment, the first data packet may also be any data packet in the data packet set.

In an embodiment of the present disclosure, a first network node sends auxiliary information including packet discarding strategy information to a second network node. The packet discarding strategy information is used to indicate that a data packet associated with relatively important data should be discarded if a relatively important data packet in a data packet set fails to be sent, which allows the second network node to accurately discard the associated data packet.

For example, the data packet set includes N first data packets, of which M are first data packets. N and M are integers greater than 0, and M is less than or equal to N. The ratio of N to M is greater than or equal to a predetermined threshold. The first network node sends auxiliary information to the second network node, and the auxiliary information includes packet discarding strategy information. The packet discarding strategy information is used to indicate that when the number of first data packets in the data packet set that fail to be sent is greater than or equal to the predetermined threshold, the second data packet associated with the first data packet is discarded. The second network node discards the data packet set and/or discards the second data packet in the data packet set and/or discards other data packet sets where the second data packet is located. In this case, the second network node does not need to send the second data packet, etc. Here, the first data packet can be any data packet in the data packet set or a data packet whose weight is greater than or equal to a predetermined weight.

In an embodiment of the present disclosure, a first network node sends auxiliary information including packet discarding strategy information to a second network node, where the packet discarding strategy information is used to indicate: if a relatively important data packet in a data packet set fails to be sent, a data packet associated with relatively important data is discarded, and/or if the number of the relatively important data packets that fail to be sent is greater than or equal to a predetermined threshold, the data packet associated with relatively important data is discarded; or the packet discarding strategy information is used to indicate that if the number of failed data packets in a data packet set is greater than a certain quantity, other data packets associated with the data packet are discarded, which allows the second network node to accurately discard the associated data packet.

It should be noted that those skilled in the art can understand that the method provided in the embodiments of the present disclosure can be executed alone or together with some methods in the embodiments of the present disclosure or some methods in the related art.

In some embodiments, the auxiliary information includes: association information; and the association information is used to indicate an association relationship between data packets or the association information is used to indicate an association relationship between the data packet and a data packet set.

The present disclosure provides an information processing method, which is performed by a first network node and includes the following steps.

In step S51, auxiliary information is sent to the second network node; and the auxiliary information includes association information.

As shown in FIG. 5, an embodiment of the present disclosure provides an information processing method, which is performed by a first network node and includes the following steps.

In step S51, auxiliary information is sent to the second network node; and the auxiliary information includes: association information, where the association information is used to indicate an association relationship between data packets or the association information is used to indicate an association relationship between the data packet and a data packet set.

In some embodiments of the present disclosure, the first network node and the second network node may be the first network node and the second network node respectively in the above embodiments; the data packet and the data packet set may be the data packet and the data packet set respectively in the above embodiments; and the auxiliary information may be the auxiliary information in the above embodiments.

In some embodiments, the association information is used to indicate but not limited to at least one of the following:
a first sequence number of the data packet belonging to a second sequence number of the data packet set;
the second sequence number of the data packet set including the first sequence number of at least one of the data packets;
a stop identifier in the data packet set;
the second sequence number of the data packet set to which a certain or arbitrary data packet belongs;
the number of data packets in the data packet set that are already in the first network node; and
the number of remaining data packets in the data packet set that are about to be sent at the second network node within the data packet set.

In some further embodiments, the association information is used to indicate the second sequence number of at least one data packet set.

Here, the first sequence number may be a DL COUNT value.

Here, the first sequence number and the second sequence number may be any identification information. For example, the identification information may be but not limited to an index value, a number or an identifier, etc. The first sequence number is used to uniquely identify a data packet in a data packet set; and the second sequence number is used to uniquely identify a data packet set.

Here, the stop identifier is used to indicate whether the data packet set is stopped. The data packet being stopped refers to the last data packet in the data packet set.

Here, when the stop identifier is first indication information, it is used to indicate that the data packet set is stopped; or when the stop identifier is second indication information, it is used to indicate that the data packet set is not stopped. For example, the first indication information may be “YES” or any other character indicating that the data packet set is stopped. The second indication information may be “NO” or any other character indicating that the data packet set is not stopped.

Exemplarily, the data packet set includes 100 data packets. The first network node sends auxiliary information to the second network node, and the auxiliary information includes association information. The association information includes the first sequence number “100” of the 100th data packet and second indication information. The second network node determines that the transmission of the data packet set has been completed (that is, the 100th data packet is the last data packet in the data packet set).

Exemplarily, the first network node sends auxiliary information to the second network node, and the auxiliary information includes association information. The association information is used to indicate that: the data packets with DL COUNT values of “0” and “1” belong to a data packet set “1”, and the data packets with DL COUNT values of “2” and “3” belong to a data packet set “2”. If the second network node determines that the data packets with DL COUNT values of “0” and/or “1” fail to be sent, it determines that data packet set “1” is discarded; and/or if the second network node determines that the data packets with DL COUNT values of “2” and/or “3” fail to be sent, it determines that data packet set “2” is discarded.

Exemplarily, the first network node sends auxiliary information to the second network node, and the auxiliary information includes association information. The association information is used to indicate that: a data packet set “1” includes data packets with DL COUNT values of “0” and “1”, and a data packet set “2” includes DL COUNT values of “2” and “3”. If the second network node determines that the data packets with DL COUNT values of “0” and/or “1” have failed to be sent and determines that data packet set “1” is discarded, for new data packets that are subsequently received from the core network, if the data packet set associated with the new data packets is also “1”, these new data packets are discarded without being sent; and/or if the second network node determines that the data packets with DL COUNT values of “2” and/or “3” have failed to be sent and determines that data packet set “2” is discarded, for new data packets that are subsequently received from the core network, if the data packet set associated with the new data packets is also “2”, these new data packets are discarded without being sent.

In the above embodiments, the association information may include: second indication information “NO” associated with data packet set “1”, and second indication information “NO” associated with data packet set “2”. In this way, the second network node may determine that data packet set “1” and data packet set “2” are not stopped.

As an embodiment, for packets to which the source base station (such as the first network node) has not allocated the first sequence number in time, the source base station (such as the first network node) will directly notify the second sequence number of the data packet set to which the data packet belongs.

Thus, in the embodiments of the present disclosure, the association relationship between data packets and/or the association relationship between the data packet and the data packet set can be indicated by association information, so that the second network node can accurately know the data packets or data packet sets that need to be discarded in batches.

It should be noted that those skilled in the art can understand that the method provided in the embodiments of the present disclosure can be executed alone or together with some methods in the embodiments of the present disclosure or some methods in the related art.

An embodiment of the present disclosure provides an information processing method, which is executed by a first network node and includes: sending auxiliary information to a second network node.

Here, the auxiliary information may be carried by signaling plane information. For example, the auxiliary information is carried in the SN State Transfer. Alternatively, the auxiliary information is carried in user plane signaling and sent.

In some embodiments, sending the auxiliary information to the second network node includes at least one of the following:
sending auxiliary information to the second network node through signaling plane information; and
sending the auxiliary information to the second network node through user plane signaling.

As an embodiment, when the first base station previously transmits data to the second base station, the GTP-U packet header carries information of the data packet set. The information of the data packet set may be, but is not limited to, the SN number of the belonging data packet set (such as the Packet set), etc., or the information of the data packet set may be the association information in the above embodiments. In this case, the second base station receives the packet and can also know the association information of the previously transmitted packet and the packet set. Here, the first base station may be replaced by the first network node in the above embodiments; and the second base station may be replaced by the second network node in the above embodiments.

As an embodiment, the GTP-U header may carry: basic parameters, where the basic data includes but is not limited to at least one of the following:
PDU set sequence number (SN);
identifiers of the start PDU and end PDU in the PDU set;
the PDU sequence number in the PDU set;
the number of PDUs in the PDU set and the size of the PDU set (in bytes);
the importance or importance level of the Packet set; and
the sequence number of the important PDU in the PDU Set.

Here, the importance level may refer to the priority level in the above embodiment.

In this way, in the embodiment of the present disclosure, the second network node (such as the second base station) receives the GTP-U and can perform batch processing on the data packets based on the association relationship, such as packet discarding, etc.

As an embodiment, for the PDCP SDU to which the source base station (i.e., the first network node) has allocated a DL COUNT value or SN number, the information of the data packet set will be carried in the GTP-U header. In this case, after receiving the information, the target base station (i.e., the second network node) will know the association relationship where the first sequence number (downlink COUNT value) of the data packet belonging to the second sequence number (data packet set SN) of the data packet set.

As an embodiment, for the PDCP SDU to which the source base station has not allocated a downlink COUNT value or SN number in time, the information of the data packet set will be carried in the GTP-U packet header. After receiving the information, the target base station will know that the data packet belongs to the second sequence number of the data packet set.

In some embodiments, the auxiliary information includes: state information; and the state information is used to indicate whether the data packet fails to be sent.

As shown in FIG. 6, an embodiment of the present disclosure provides an information processing method, which is performed by a first network node and includes the following steps.

In step S61, auxiliary information is sent to a second network node; and the auxiliary information includes: state information, where the state information is used to indicate whether a data packet fails to be sent.

Here, whether the data packet fails to be sent includes whether the data packet was successfully sent or failed to be sent.

Here, the failure to send the data packet may be, but is not limited to the following situations: the data packet times out and is not sent, or the data packet is sent but not received by the second network node, or the second network node does not give a feedback response for successful transmission within a limited time, or the second network node gives a feedback response for unsuccessful transmission.

In some embodiments of the present disclosure, the first network node and the second network node may be the first network node and the second network node respectively in the above embodiments; the data packet and the data packet set may be the data packet and the data packet set respectively in the above embodiments; and the auxiliary information may be the auxiliary information in the above embodiments.

In some embodiments, the state information is used to indicate but is not limited to at least one of the following:
a first sequence number of the data packet that fails to be sent;
the first sequence number of the data packet that fails to be sent and a second sequence number of a data packet set associated with the first sequence number of the data packet that fails to be sent; and
the first sequence number of the data packet that fails to be retransmitted.

In one embodiment, the state information may be used to indicate that the data packet fails to be sent. Here, the state information may be directly used to indicate that the data packet fails to be sent.

In one embodiment, the state information includes third indication information or fourth indication information; the third indication information indicates that the data packet fails to be sent, or the fourth indication information indicates that the data packet is successfully sent.

The present disclosure provides an information processing method, which is performed by a first network node and includes:
determining that the data packet requested to be retransmitted by the HARQ is a data packet that fails to be sent based on the HARQ being greater than or equal to a predetermined number of times;
and/or,
determining a data packet that fails to be sent based on a PDCP state report obtained from the UE, where the PDCP state report is used to at least indicate a first sequence number of the data packet that fails to be sent.

Exemplarily, the first network node sends auxiliary information to the second network node, and the auxiliary information includes state information, where the state information includes data packets with DL COUNT values of “0” and “1”. The second network node may determine that the transmission of the data packets with DL COUNT values of “0” and “1” fails based on the state information.

Exemplarily, the first network node sends auxiliary information to the second network node, the auxiliary information including state information, where the state information includes: data packets with DL COUNT values of “0” and “1”, and data packet set “1” associated with the data packets with DL COUNT values of “0” and “1”. The second network node may determine, based on the state information, that the transmission of data packets with DL COUNT values of “0” and “1” in data packet set “1” fails.

Exemplarily, the first network node determines that the number of retransmissions of the data packet with a DL COUNT value of “0” is 5 times, which exceeds the predetermined number of times. The first network node sends auxiliary information to the second network node, and the auxiliary information includes state information, where the state information includes: the data packet with a DL COUNT value of “0” and the number of retransmissions. The second network node may determine that the transmission of the data packet with a DL COUNT value of “0” has failed based on the state information.

In the embodiments of the present disclosure, the first network node sends state information to the second network node, so that the second network node can determine the data packet that fails to be sent.

When the second network node determines that transmission of the data packet fails, the second network node may discard associated data packets according to a packet discarding strategy.

Furthermore, in the embodiments of the present disclosure, there is no need for the first network node or other network node to send a data packet and/or a data packet set to the second network node. It is only necessary to send the first sequence number of the data packet and/or the second sequence number of the data packet set to the second network node to instruct the second network node to discard the data packet and/or the data packet set. This can reduce signaling overhead and energy consumption of the first network node and the second network node.

It should be noted that those skilled in the art can understand that the method provided in the embodiments of the present disclosure may be executed alone or together with some methods in the embodiments of the present disclosure or some methods in the related art.

The following is based on an information processing method, which is performed by a second network node and is similar to the description of the information processing method performed by the first network node mentioned above. For technical details not disclosed in the information processing method embodiment performed by the second network node, please refer to the description of the information processing method example performed by the first network node, and no detailed description is given here.

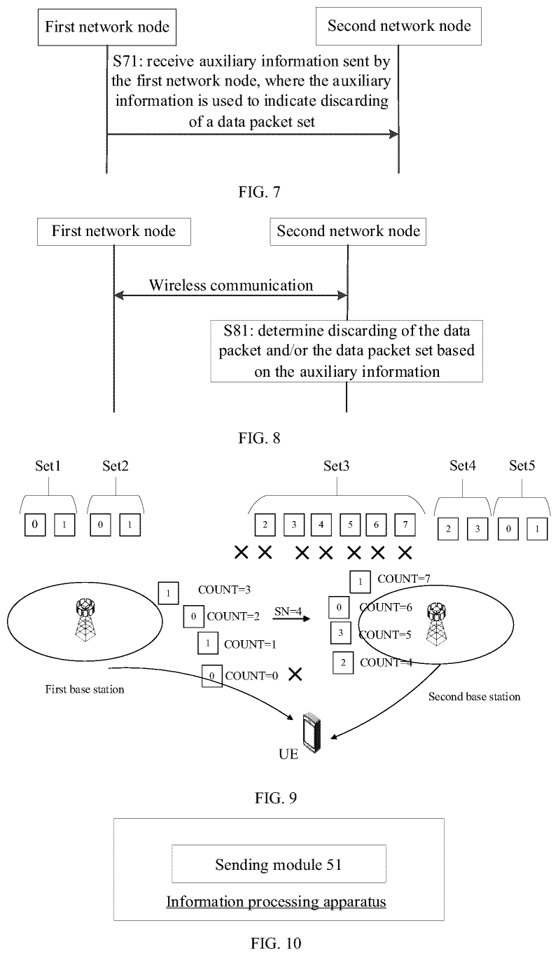

As shown in FIG. 7, an embodiment of the present disclosure provides an information processing method, which is performed by a second network node and includes the following steps.

In step S71, auxiliary information sent by a first network node is received, where the auxiliary information is used to indicate discarding of a data packet set.

In some embodiments of the present disclosure, the first network node and the second network node may be the first network node and the second network node respectively in the above embodiments; the data packet and the data packet set may be the data packet and the data packet set respectively in the above embodiments; and the auxiliary information may be the auxiliary information in the above embodiments.

Here, the data packet may be: a part of data packets or all of the data packets in at least one data packet set.

In one embodiment, the auxiliary information is used to indicate the discarding of a part of data packets in at least one data packet set and/or the discarding of all data packets in at least one data packet set; and one data packet set includes one data packet or multiple data packets.

For example, the first network node is a master node, and the second network node is a secondary node.

Alternatively, the first network node is a secondary node, and the second network node is a master node.

Alternatively, the first network node is a source base station, and the second network node is a target base station.

Alternatively, the first network node is a first base station, and the second network node is a second base station.

For example, a data packet set is a PDU set; a data packet is a PDU; and the PDU set includes at least one PDU.

In this way, in the embodiment of the present disclosure, the second network node can accurately know the data packets that need to be discarded in batches or the data packet sets that need to be discarded, thereby reducing the occurrence of network congestion.

In some embodiments, the auxiliary information includes: packet discarding strategy information.

In some embodiments, the packet discarding strategy information is used to indicate at least one of the following:
when the first data packet in the data packet set fails to be sent, the second data packet associated with the first data packet being discarded; and
if the number of the first data packets that fails to be sent in the data packet set is greater than or equal to a predetermined threshold, the second data packet associated with the first data packet being discarded, where the first data packet is any data packet in the data packet set or a data packet whose weight is greater than or equal to a predetermined weight.

In some embodiments, the second data packet includes at least one of the following:
a data packet in the same data packet set as the first data packet; and
a data packet in a different data packet set than the first data packet.

In some embodiments, the auxiliary information includes: association information; and the association information is used to indicate an association relationship between data packets or the association information is used to indicate an association relationship between the data packet and a data packet set.

In some embodiments, the association information is used to indicate one of the following indications:
the first sequence number of the data packet belonging to the second sequence number of the data packet set;
the second sequence number of the data packet set including the first sequence number of at least one of the data packets;
a stop identifier in the data packet set;
the second sequence number of the data packet set to which any data packet belongs;
the number of data packets in the data packet set that are already in the first network node; and
the number of remaining data packets in the data packet set that are about to be sent at the second network node within the data packet set.

In some embodiments, the auxiliary information includes: state information; and the state information is used to indicate whether the data packet fails to be sent.

In some embodiments, the state information is used to indicate at least one of the following:
a first sequence number of the data packet that fails to be sent;
the first sequence number of the data packet that fails to be sent and a second sequence number of a data packet set associated with the first sequence number of the data packet that fails to be sent; and
the first sequence number of the data packet that fails to be retransmitted.

For the above implementations, reference may be made to the description on the first network node side for details, which will not be described again here.

It should be noted that those skilled in the art can understand that the method provided in the embodiments of the present disclosure can be executed alone or together with some methods in the embodiments of the present disclosure or some methods in the related art.

An embodiment of the present disclosure provides an information processing method, which is performed by a second network node, including: determining a data packet that fails to be sent based on state information received from a first network node; or determining a data packet that fails to be sent based on a DPCP state report obtained from a UE, where the PDCP state report is used to indicate a first sequence number of the data packet that fails to be sent.

Here, the PDCP state report may include the first sequence number of the data packet, and the PDCP state report is used to indicate the data packet that fails to be sent.

In the embodiments of the present disclosure, the second network node may obtain the data packet that fails to be sent in a variety of ways, which may be applicable to more application scenarios on the one hand, and facilitate the subsequent determination of discarding of data packets and/or data packet sets on the other hand.

As shown in FIG. 8, an embodiment of the present disclosure provides an information processing method, which is performed by a second network node and includes the following steps.

In step S81, the discarding of the data packet and/or the data packet set is determined based on the auxiliary information.

In some embodiments of the present disclosure, the auxiliary information may be the auxiliary information in the above embodiments; the packet discarding strategy information, the association information and the state information may be the packet discarding strategy information, the association information and the state information in the above embodiments respectively.

In one embodiment, determining the discarding of the data packet in step S81 includes: determining the data packet and/or data packet set to be discarded, and discarding the data packet and/or data packet set. Here, the data packet to be discarded may be a target data packet, and the data packet set to be discarded may be a target data packet set.

In some embodiments, the step S81 includes but is not limited to at least one of the following:
determining the data packet and/or data packet set that needs to be discarded based on packet discarding strategy information;
determining the data packet and/or data packet set that needs to be discarded based on the packet discarding strategy information and association information;
determining the data packet and/or data packet set that needs to be discarded based on state information and the association information, and
determining the data packet and/or data packet set that needs to be discarded based on the state information.

The above embodiments may be combined.

The embodiment of the present disclosure provides an information processing method, which is performed by a second network node, and includes: determining a data packet and/or a data packet set that needs to be discarded based on packet discarding strategy information.

In one embodiment, the second network node stores the first sequence number of the data packet and the second sequence number of the data packet set associated with the first sequence number of the data packet.

Exemplarily, the second network node receives packet discarding strategy information sent by the first network node, and the packet discarding strategy information is used to indicate that when a first data packet whose weight is greater than or equal to 0.7 fails, a second data packet associated with the first data packet whose weight is greater than or equal to 0.7 is discarded. The second network node discards the second data packet associated with the first data packet whose weight is greater than 0.7, and/or discards the data packet set where the first data packet whose weight is greater than 0.7 is located.

Exemplarily, the second network node may determine the data packet and/or data packet set to be discarded based on the packet discarding strategy information and the first sequence number of the data packet; or the second network node may determine the data packet and/or data packet set to be discarded based on the packet discarding strategy information, the first sequence number of the data packet, and the second sequence number of the data packet set associated with the first sequence number of the data packet. For example, the second network node receives auxiliary information, and the auxiliary information includes the packet discarding strategy information. The second network node obtains data packets with first sequence numbers of “0” and “1”. The second network node may discard the data packets and/or data packet set associated with the first sequence numbers “0” and “1” based on the packet discarding strategy information.

The embodiment of the present disclosure provides an information processing method, which is performed by the second network node, and includes: determining a data packet and/or a data packet set that needs to be discarded based on packet discarding strategy information and association information.

Exemplarily, the second network node receives auxiliary information, and the auxiliary information includes the packet discarding strategy information and the association information, where the association information is used to indicate that the data packets with the first sequence numbers of “0” and “1” are associated with the data packet set with the second sequence number of “1”; and the packet discarding strategy information is used to indicate: when the number of data packets that fails to be sent in the data packet set is greater than or equal to 10, the data packet set to which the data packets belong is discarded. The second network node determines that there are 10 data packets that fail to be sent, and the 10 data packets include a data packet with the first sequence number of “1”; the second network node discards the data packet set with the second sequence number of “1”.

The embodiment of the present disclosure provides an information processing method, which is performed by the second network node, and includes: determining a data packet and/or a data packet set that needs to be discarded based on state information and association information.

Exemplarily, the second network node receives auxiliary information, the auxiliary information includes the state information and the association information; and the state information is used to indicate data packets with first sequence numbers of “0”, “1”, and “3”. The association information is used to indicate that: data packets with first sequence numbers of “0” and “1” are associated with a data packet set with a second sequence number of “1”, and a data packet with the first sequence number of “3” is associated with a data packet set with a second sequence number of “2”. The second network node determines that data packets “0”, “1”, and “3” need to be discarded, or determines that data packet sets “1” and “2” need to be discarded.

An embodiment of the present disclosure provides an information processing method, which is performed by the second network node, and includes: determining a data packet and/or a data packet set that needs to be discarded based on state information.

Exemplarily, the second network node may store the association information. After receiving the state information, the second network node may determine the data packet and/or data packet set that needs to be discarded based on the state information and the association information.

In the embodiments of the present disclosure, the second network node may determine the discarding of the data packet and/or the data packet set through the auxiliary information, thereby accurately implementing the discarding of batch data packets and/or data packet sets.

In addition, the second network node can determine the data packet and/or data packet set that needs to be discarded through various ways such as packet discarding strategy information, or packet discarding strategy information and association information, or state information and association information, or state information, etc. In this way, the discarding of data packets and/or data packet sets in various ways can be achieved to adapt to more application scenarios.

For the above implementations, please refer to the description on the first network node side for details, which will not be described again here.

It should be noted that those skilled in the art can understand that the method provided in the embodiments of the present disclosure can be executed alone or together with some methods in the embodiments of the present disclosure or some methods in the related art.

In order to further explain any embodiment of the present disclosure, a specific embodiment is provided below.

The present disclosure provides an information processing method, which is performed by a first network node and a second network node, and includes the following steps.

In step S91, the first network node sends auxiliary information to the second network node; and the auxiliary information is used to indicate the discarding of the data packet;

For example, the auxiliary information is used to indicate the discarding of at least one data packet set; and one data packet set includes at least one data packet.

For example, the first network node is a master node, and the second network node is a secondary node.

For example, the first network node is a secondary node, and the second network node is a master node.

For example, the master node determines that the UE's bearer is switched from the master node to the secondary node, and sends the auxiliary information to the secondary node; or the master node determines that a secondary node is added to the bearer, and determines to send auxiliary information to the added secondary node; or the master node determines that the secondary node is modified, and determines to send auxiliary information to the modified secondary node.

The step S91 includes steps S91A, S91B and S91C.

In step S91A, the first network node sends auxiliary information to the second network node, where the auxiliary information includes: packet discarding strategy information;

Exemplarily, the packet discarding strategy information is used to indicate that: in the data packet set, the data packet with a weight greater than or equal to a predetermined weight fails to be sent, and the data packet associated with the data packet with a weight greater than or equal to the predetermined weight is discarded. The data packet with a weight greater than or equal to the predetermined weight may be an I-frame data packet. Here, the data packet with a weight greater than or equal to the predetermined weight may be the first data packet in the above embodiments. The data packet associated with the data packet with a weight greater than or equal to the predetermined weight may be the second data packet in the above embodiments.

Exemplarily, the packet discarding strategy information is used to indicate that if the number of the data packets that fail to be sent in the data packet set is greater than or equal to a predetermined threshold, a data packet associated with the data packet is discarded. The predetermined threshold may be 80% of the data packets in the data packet set.

Exemplarily, the packet strategy information is used to indicate that: the number of failed transmissions of the data packet with a weight greater than or equal to a predetermined weight in the packet set is greater than or equal to a predetermined threshold, and a data packet associated with the data packets with a weight greater than or equal to the predetermined weight are discarded.

Exemplarily, the data packet and the associated data packet may be in the same data packet set or in different data packet sets. For example, the first data packet and the second data packet may be in the same data packet set or in different data packet sets.

Exemplarily, the packet discarding strategy information includes the second sequence number of the data packet set, and the packet discarding strategy information is used to indicate that the data packet is discarded; and/or, the packet discarding strategy information includes the first sequence number of the data packet, and the packet discarding strategy information is used to indicate that the data packet is discarded or other data packets of the data packet set to which it belongs are discarded.

Exemplarily, the packet discarding strategy information includes a list, the list includes a second sequence number list of one or more data packet sets, and the packet discarding strategy information is used to indicate that the one or more data packet sets are discarded. The packet discarding strategy information includes a list, the list includes a first sequence number list of one or more data packets, and the packet discarding strategy information is used to indicate that the one or more data packets are discarded or other data packets of the data packet set to which the data packets belong are discarded.

In this way, the scope of discarding a data packet or a data packet set can be notified in an explicit manner. The first base station directly notifies the target base station of the packet discarding; for example, discarding the data packet set corresponding to the SN number of the data packet set, or discarding the data packet set corresponding to the SN number of a list. The advantage of this is that the first base station can directly notify the second base station of the packet discarding operation, making implementing the second base station simpler.

In step S91B, the first network node sends auxiliary information to the second network node, where the auxiliary information includes: association information;

Exemplarily, the association information is used to indicate the association relationship between the first sequence number of the data packet and the second sequence number of the data packet set. For example, the association information is used to indicate: the association relationship between the data packets with DL COUNT values of “0” and “1” and the data packet set “1”, and the association relationship between the data packets with DL COUNT values of “2” and “3” and the data packet set “2”.

Exemplarily, the association information is used to indicate the second sequence number of the data packet set, and the second sequence of the data packet set includes the first sequence number indicating one data packet, the first sequence number of the stop data packet and/or a stop identifier in the data packet set. For example, the association indication information includes: data packet set “1” including data packets with DL COUNT values of “0” and “1”, and the stop identifier “NO” of data packet set “1”, and data packet set “2” including data packets with DL COUNT values of “2” and “3”, and the stop identifier “NO” of data packet set “2”.

In step S91C, the first network node sends auxiliary information to the second network node, where the auxiliary information includes: state information;

Exemplarily, the first network node determines that the data packet “1” fails to be sent; and the first network node sends the state information including a DL COUNT value of the data packet “1” to the second network node.

Exemplarily, the first network node determines that data packet “1” in data packet set “1” fails to be sent; and the first network node sends the state information including the second sequence number of the data packet set being “1” and the first sequence number of the data packet being “1” to the second network node.

Exemplarily, the first network node may determine that the data packet requested to be retransmitted by HARQ is a data packet that fails to be sent based on the HARQ being greater than or equal to a predetermined number of times.

In step S92, the second network node determines the discarded data packet and/or data packet set based on the auxiliary information.

Exemplarily, the second network node obtains the data packet and/or data packet set to be discarded according to the DL COUNT value of the data packet that fails to be sent and the auxiliary information. For example, in the first step, the associated data packet set obtained by the network node according to the DL COUNT value of the data packet that fails to be sent is the target data packet set for the batch packet discarding operation to be performed. In the second step, the second network node discards packets according to the packet discarding strategy information.

Exemplarily, the second network node discards other data packets in the data packet set associated with the data packet that fails to be sent and no longer sends them. Here, other data packets in the data packet set may be data packets waiting to be retransmitted and/or new data packets obtained from the core network.

Exemplarily, the second network node obtains the data packet set to which the data packet that fails to be sent belongs based on the proportion of the data packet that fails to be sent in the data packet set (e.g., combining the data packet that fails to be sent obtained from the first network node and/or the data packet that fails to be sent obtained from the PDCP state report of the UE) and the DL COUNT value obtained thereafter; and discards all other data packets in the data packet set to which it belongs and no longer sends them. Here, the other data packets in the data packet set may be data packets waiting for retransmission and/or new data packets obtained from the core network.

For example, the second network node determines the data packet that fails to be sent based on a PDCP state report sent by the UE and/or based on the received state information sent by the first network node.

As shown in FIG. 9, in an optional embodiment, the first network node sends auxiliary information to the second network node; the auxiliary information is used to indicate or include one of the following information: the sequence number (SN) of the data packet set being “set1”; the data packet set “set1” including data packets with DL COUNT values of “0” and “1” respectively; the data packet set “set1” including a stop identifier “NO”; the sequence number (SN) of the data packet set being “set2”; the data packet set “set2” including data packets with DL COUNT values of “2” and “3” respectively; the data packet set “set2” including a stop identifier “NO”. The auxiliary information sent by the first network node to the second network node includes state information, and the state information is used for indicating that the data packet with a DL COUNT value of “0” fails to be sent or the second network node may learn from the state report reported by the UE that the data packet with a DL COUNT value of “0” fails to be sent. The second network node determines that the data packets with DL COUNT values of “2”, “3”, “4”, “5”, “6” and “7” in the data packet set “set1” are discarded. Here, the second network node may also send data packets in the data packet set “set2” and the data packet set “set3”.

Thus, in the embodiment of the present disclosure, the first network node sends the auxiliary information to the second network node, and the second network node can determine the data packet set to be discarded based on the auxiliary information, so that the second network node can discard data packets in batches. In this way, the occurrence of network congestion can be reduced.

As shown in FIG. 10, an embodiment of the present disclosure provides an information processing apparatus, including:
a sending module 51, configured to send auxiliary information to a second network node, where the auxiliary information is used to indicate discarding of a data packet.

The information processing apparatus provided by the embodiment of the present disclosure may be a first network node.

In some embodiments, the data packet is: a part of data packets or all of the data packets in at least one data packet set.

In some embodiments, the first network node is a master node, and the second network node is a secondary node;

or,

the first network node is a secondary node, and the second network node is a master node.

In some embodiments, the sending module 51 is configured to send the auxiliary information to the second network node based on a bearer of a UE being switched from the first network node to the second network node.

In some embodiments, the sending module 51 is configured to send the auxiliary information to the second network node based on the second network node being added to the bearer of the UE.

In some embodiments, the sending module 51 is configured to send the auxiliary information to the second network node based on the second network node being modified in the bearer of the UE.

In some embodiments, the auxiliary information includes: packet discarding strategy information.

In some embodiments, the packet discarding strategy information is used to indicate at least one of the following:
when the first data packet in the data packet set fails to be sent, discarding all data packets in the data packet set associated with the first data packet; and
if the number of failed first data packets in the data packet set is greater than or equal to a predetermined threshold, discarding the second data packet associated with the first data packet, where the first data packet is any data packet in the data packet set or a data packet whose weight is greater than or equal to a predetermined weight.

In some embodiments, the second data packet includes at least one of the following:
a data packet in the same data packet set as the first data packet; and
a data packet in a different data packet set than the first data packet.

In some embodiments, the auxiliary information includes: association information; and the association information is used to indicate an association relationship between data packets or the association information is used to indicate an association relationship between the data packet and a data packet set.

In some embodiments, the association information is used to indicate one of the following indications:
a first sequence number of the data packet belonging to a second sequence number of the data packet set;
the second sequence number of the data packet set including the first sequence number of at least one of the data packets; and
a stop identifier in the data packet set.

In some embodiments, the auxiliary information includes: state information; and the state information is used to indicate whether the data packet fails to be sent.

In some embodiments, the state information is used to indicate at least one of the following:
a first sequence number of the data packet that fails to be sent;
the first sequence number of the data packet that fails to be sent and a second sequence number of a data packet set associated with the first sequence number of the data packet that fails to be sent; and
the first sequence number of the data packet that fails to be retransmitted.

The present disclosure provides an information processing apparatus, including: a first processing module, where,

the first processing module is configured to determine that the data packet requested to be retransmitted by the HARQ is the data packet that fails to be sent based on the HARQ being greater than or equal to a predetermined number of times; and/or,

a second processing module is configured to determine the data packet that fails to be sent based on the PDCP state report obtained from the UE, where the PDCP state report is used to at least indicate the first sequence number of the data packet that fails to be sent.

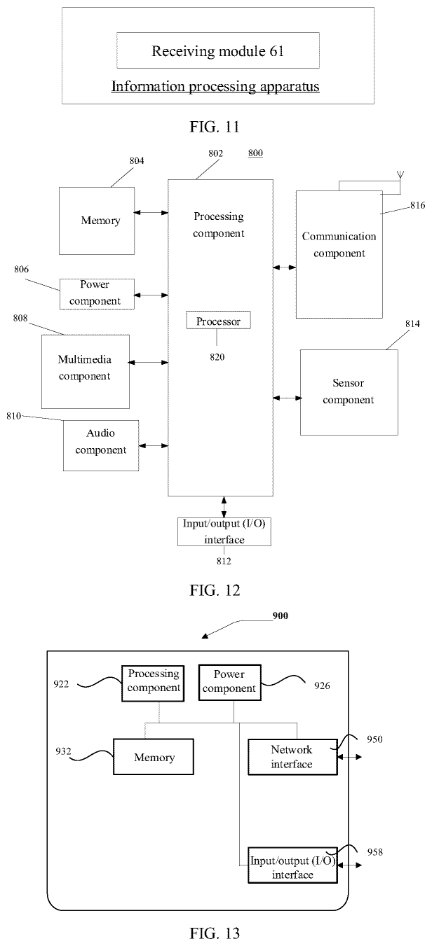

As shown in FIG. 11, an embodiment of the present disclosure provides an information processing apparatus, including:
a receiving module 61, configured to receive auxiliary information sent by a first network node, where the auxiliary information is used to indicate discarding of a data packet.

The information processing apparatus provided by the embodiment of the present disclosure may be a second network node.

In some embodiments, the data packet is: a part of the data packets or all of the data packets in at least one data packet set.

In some embodiments, the first network node is a master node, and the second network node is a secondary node;

or,

the first network node is a secondary node, and the second network node is a master node.

In some embodiments, the auxiliary information includes: packet discarding strategy information.

In some embodiments, the packet discarding strategy information is used to indicate at least one of the following:
when the first data packet in the data packet set fails to be sent, discarding all data packets in the data packet set associated with the first data packet; and
if the number of failed first data packets in the data packet set is greater than or equal to a predetermined threshold, discarding the second data packet associated with the first data packet, where the first data packet is any data packet in the data packet set or a data packet whose weight is greater than or equal to a predetermined weight.

In some embodiments, the second data packet includes at least one of the following:
a data packet in the same data packet set as the first data packet; and
a data packet in a different data packet set than the first data packet.

In some embodiments, the auxiliary information includes: association information; and the association information is used to indicate an association relationship between data packets or the association information is used to indicate an association relationship between the data packet and a data packet set.

In some embodiments, the association information is used to indicate one of the following indications:
the first sequence number of the data packet belonging to the second sequence number of the data packet set;
the second sequence number of the data packet set including the first sequence number of at least one data packet;
a stop identifier in the data packet set.

In some embodiments, the auxiliary information includes: state information; and the state information is used to indicate whether the data packet fails to be sent.

In some embodiments, the state information is used to indicate at least one of the following:
a first sequence number of the data packet that fails to be sent;
the first sequence number of the data packet that fails to be sent and a second sequence number of a data packet set associated with the first sequence number of the data packet that fails to be sent; and
the first sequence number of the data packet that fails to be retransmitted.

The present disclosure provides an information processing apparatus, including: a second processing module, where,

the second processing module is configured to determine the data packet that fails to be sent based on the received state information sent by the first network node;

or,

the second processing module is configured to determine the data packet that fails to be sent based on the PDCP state report obtained from the UE, where the PDCP state report is used to indicate a first sequence number of the data packet that fails to be sent.

An embodiment of the present disclosure provides an information processing apparatus, including: a second processing module, configured to determine discarding of the data packet and/or the data packet set based on the auxiliary information.

The present disclosure provides an information processing apparatus, including: a second processing module, configured to perform one of the following:
determining the data packet and/or data packet set that needs to be discarded based on packet discarding strategy information;
determining the data packet and/or data packet set that needs to be discarded based on the packet discarding strategy information and association information;
determining the data packet and/or data packet set that needs to be discarded based on state information and the association information, and
determining the data packet and/or data packet set that needs to be discarded based on the state information.

It should be noted that those skilled in the art can understand that the apparatus provided in the embodiments of the present disclosure can be executed alone or together with some apparatus in the embodiments of the present disclosure or some apparatus in the related art.

Regarding the apparatus in the above embodiments, the specific manner in which each module performs operations has been described in detail in the embodiments of the method, and will not be elaborated here.

The present disclosure provides a communication device, including:
a processor; and
a memory for storing processor-executable instructions;
where the processor is configured to implement the information processing method of any embodiment of the present disclosure when running executable instructions.

In one embodiment, the communication device may include but is not limited to at least one of: the UE and network device. The network device includes a base station.

The processor may include various types of storage media, which are non-temporary computer storage media that can continue to memorize information stored thereon after the user equipment loses power.

The processor may be connected to the memory via a bus or the like, and may be used to read an executable program stored in the memory, for example, at least one of the methods shown in FIG. 3 to FIG. 8.

The present disclosure also provides a computer storage medium storing a computer executable program, the executable program, when being executed by a processor, implements the information processing method of any embodiment (e.g., at least one of the methods shown in FIG. 3 to FIG. 8) of the present disclosure.

Regarding the apparatus or storage medium in the above embodiment, the specific manner in which each module performs the operation has been described in detail in the embodiment of the method, and will not be elaborated here.

The technical solution provided by the embodiments of the present disclosure may have the following beneficial effects:

In the embodiments of the present disclosure, the first network node sends the auxiliary information to the second network node so that the second network node can accurately know the discarding of the data packet. In addition, if the second network node achieves the discarding of the data packet, the occurrence of network congestion can also be reduced.

FIG. 12 is a block diagram of a user equipment 800 according to an exemplary embodiment. For example, the user equipment 800 may be a mobile phone, a computer, a digital broadcasting terminal, a messaging device, a game console, a tablet device, a medical device, a fitness device, a personal digital assistant, etc.

Referring to FIG. 12, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 usually controls the overall operations of the user equipment 800, such as operations associated with display, telephone call, data communication, camera operation, and recording operation. The processing component 802 may include one or more processors 820 to execute instructions to complete all or part of the steps of the above method. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support the operations at the user equipment 800. Examples of these data include instructions for any application or method operated on the user equipment 800, contact data, phone book data, messages, pictures, videos, etc. The memory 804 may be implemented by any type of volatile or non-volatile storage device or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk or optical disk.

The power component 806 provides power for various components of the user equipment 800. The power component 806 may include a power management system, one or more power sources, and other components associated with g power generation, management and distribution of the user equipment 800.

The multimedia component 808 includes a screen that provides an output interface between the user equipment 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of a touch or slide, but also detect the duration and pressure associated with the touch or slide operation. In some embodiments, the multimedia component 808 includes a front camera and/or a rear camera. When the user equipment 800 is in an operating mode, such as a shooting mode or a video mode, the front camera and/or the rear camera may receive external multimedia data. Each front camera and rear camera may be a fixed optical lens system or have a focal length and optical zoom capability.

The audio component 810 is configured to output and/or input an audio signal. For example, the audio component 810 includes a microphone (MIC), and when the user equipment 800 is in an operation mode, such as a call mode, a recording mode, and a voice recognition mode, the microphone is configured to receive an external audio signal. The received audio signal may be further stored in the memory 804 or sent via the communication component 816. In some embodiments, the audio component 810 further includes a speaker for outputting audio signals.

The I/O interface 812 provides an interface between the processing component 802 and a peripheral interface module. The peripheral interface module may be a keyboard, a click wheel, buttons, etc. These buttons may include, but are not limited to a home button, a volume button, a start button, and a lock button.

The sensor component 814 includes one or more sensors for providing various aspects of state assessment for the user equipment 800. For example, the sensor component 814 may detect an on/off state of the user equipment 800, and relative positions of components, such as a display and a keypad of the user equipment 800. The sensor component 814 may also detect a position change of the user equipment 800 or a component of the user equipment 800, the presence or absence of contact between the user and the user equipment 800, an orientation or acceleration/deceleration of the user equipment 800, and a temperature change of the user equipment 800. The sensor component 814 may include a proximity sensor configured to detect the presence of nearby objects without any physical contact. The sensor component 814 may further include an optical sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate communication between the user equipment 800 and other devices in a wired or wireless manner. The user equipment 800 can access a wireless network based on a communication standard, such as WiFi, 4G or 5G, or a combination thereof. In an exemplary embodiment, the communication component 816 receives a broadcast signal or broadcast association information from an external broadcast management system via a broadcast channel. In an exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the apparatus 200 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In an exemplary embodiment, a non-transitory computer-readable storage medium including instructions is also provided, such as a memory 204 including instructions. The aforementioned instructions are executable by a processor 220 in the apparatus 200, for completing the above methods. For example, the non-transitory computer-readable storage medium may be a ROM, a random access memory (RAM), a CD-ROM, a magnetic tape, a floppy disc, an optical data storage device, and the like.

As shown in FIG. 13, an embodiment of the present disclosure illustrates a structure of a base station. For example, the base station 900 may be provided as a network side device. Referring to FIG. 13, the base station 900 includes a processing component 922, which further includes one or more processor, and a memory resource represented by a memory 932 for storing instructions, such as an application, that may be executed by the processing component 922. The application program stored in the memory 932 may include one or more modules, each corresponding to a set of instructions. In addition, the processing component 922 is configured to execute instructions to perform any of the aforementioned methods applied to the base station.

The base station 900 may also have a power component 926 configured to perform power management of the base station 900, a wired or wireless network interface 950 configured to connect the base station 900 to the network, and an input/output (I/O) interface 958. The base station 900 may operate based on an operating system stored in the memory 932, such as a Windows Server™, a Mac OS X™, a Unix™, a Linux™, a Free BSD™ or the like.

Those skilled in the art will readily appreciate other implementation solutions of the present disclosure after considering the specification and practicing the disclosure disclosed herein. The present disclosure is intended to cover any variations, uses or adaptations of the present disclosure that follow the general principles of the present disclosure and include common knowledge or customary technical means in the art that are not disclosed in the present disclosure.

It should be understood that the present disclosure is not limited to the exact structures that have been described above and shown in the accompanying drawings, and various modifications and changes may be made without departing from the scope thereof. The scope of the present disclosure is limited only by the appended claims.

1. A method for information processing performed by a first network node, the method comprising:
sending auxiliary information to a second network node, wherein the auxiliary information is used to indicate discarding of a data packet.

2. The method according to claim 1, wherein the data packet is: a part of data packets or all of the data packets in at least one data packet set.

3. The method according to claim 1, wherein,
the first network node is a master node, and the second network node is a secondary node;
or,
the first network node is the secondary node, and the second network node is the master node.

4. The method according to claim 1, wherein sending the auxiliary information to the second network node comprises at least one of following:
sending the auxiliary information to the second network node based on a bearer of a UE being switched from the first network node to the second network node;
sending the auxiliary information to the second network node based on the second network node being added to the bearer of the UE; or
sending the auxiliary information to the second network node based on the second network node being modified in the bearer of the UE.

5. The method according to claim 1, wherein the auxiliary information comprises at least one of following:
packet discarding strategy information:
association information, wherein the association information is used to indicate an association relationship between data packets or the association information is used to indicate an association relationship between the data packet and a data packet set; or
state information, wherein the state information is used to indicate whether the data packet fails to be sent.

6. (canceled)

7. The method according to claim 5, wherein the association information is used to indicate one of following indications:
a first sequence number of the data packet belonging to a second sequence number of the data packet set;
the second sequence number of the data packet set comprising the first sequence number of at least one of the data packets; or
a stop identifier in the data packet set.

8. (canceled)

9. The method according to claim 5, wherein the state information is used to indicate at least one of following:
a first sequence number of a data packet that fails to be sent;
the first sequence number of the data packet that fails to be sent and a second sequence number of a data packet set associated with the first sequence number of the data packet that fails to be sent; or
a first sequence number of a data packet that fails to be retransmitted.

10. The method according to claim 9, wherein the method comprises at least one of following:
determining that the data packet requested to be retransmitted by a hybrid automatic repeat request (HARQ) is the data packet that fails to be sent based on the HARQ being greater than or equal to a predetermined number of times; or
determining the data packet that fails to be sent based on a PDCP state report obtained from a UE, wherein the PDCP state report is used to at least indicate the first sequence number of the data packet that fails to be sent.

11. A method for information processing, performed by a second network node, the method comprising:
receiving auxiliary information sent by a first network node, wherein the auxiliary information is used to indicate discarding of a data packet.

12. The method according to claim 11, wherein the data packet is: a part of data packets or all of the data packets in at least one data packet set.

13. The method according to claim 11, wherein:
the first network node is a master node, and the second network node is a secondary node;
or,
the first network node is the secondary node, and the second network node is the master node.

14. The method according to claim 11, wherein the auxiliary information comprises at least one of following:
packet discarding strategy information;
association information, wherein the association information is used to indicate an association relationship between data packets or the association information is used to indicate an association relationship between the data packet and a data packet set; or
state information, wherein the state information is used to indicate whether the data packet fails to be sent.

15. (canceled)

16. The method according to claim 14, wherein the association information is used to indicate one of following indications:
a first sequence number of the data packet belonging to a second sequence number of the data packet set;
the second sequence number of the data packet set comprising the first sequence number of at least one of the data packets; or a stop identifier in the data packet set.

17. (canceled)

18. The method according to claim 14, wherein the state information is used to indicate at least one of following:
a first sequence number of a data packet that fails to be sent;
the first sequence number of the data packet that fails to be sent and a second sequence number of a data packet set associated with the first sequence number of the data packet; or
a first sequence number of a data packet that fails to be retransmitted.

19. The method according to claim 11, wherein the method comprises:
determining the data packet that fails to be sent based on received state information sent by the first network node;
or,
determining the data packet that fails to be sent based on a PDCP state report obtained from a UE, wherein the PDCP state report is used to indicate a first sequence number of the data packet that fails to be sent.

20. The method according to claim 11, wherein the method comprises:
determining discarding of at least one of the data packet or a data packet set based on the auxiliary information.

21. The method according to claim 20, wherein determining the discarding of the data packet based on the auxiliary information comprises one of following:
determining at least one of the data packet or the data packet set that needs to be discarded based on packet discarding strategy information;
determining at least one of the data packet or the data packet set that needs to be discarded based on the packet discarding strategy information and association information;
determining at least one of the data packet or the data packet set that needs to be discarded based on state information and the association information; or
determining at least one of the data packet or the data packet set that needs to be discarded based on the state information.

22-23. (canceled)

24. A communication device, wherein the communication device comprises:
a processor; and
a memory for storing instructions executable by the processor;
wherein the executable instructions when executed by the processor, cause the communication device to:
send auxiliary information to a second network node, wherein the auxiliary information is used to indicate discarding of a data packet.

25. A non-transitory computer storage medium, wherein the computer storage medium stores a computer executable program, and the executable program, when executed by a processor of the first network node, causes the network node to perform the method according to claim 1.

26. A communication device, wherein the communication device comprises:
a processor; and
a memory for storing instructions executable by the processor;
wherein the executable instructions when executed by the processor cause the communication device to act as the second network node and perform the method according to claim 11.
